(19) United States
(12) Patent Application Publication
(10) Pub. No.: US 2024/0177517 A1
(43) Pub. Date: May 30, 2024

(54) Intelligent Real Time Ergonomic Management

(71) Applicant: International Business Machines Corporation, Armonk, NY (US)

(72) Inventors: Allison Kei Ishida, Alameda, CA (US); Su Liu, Austin, TX (US); Diana Isabelle Ovadia, Camarillo, CA (US); Ravithej Chikkala, Pflugerville, TX (US)

(21) Appl. No.: 18/058,955

(22) Filed: Nov. 28, 2022

(51) Int. Cl. G06V 40/10; G06Q 10/0639; G06T 7/73

(52) U.S. Cl. CPC G06V 40/103; G06Q 10/0639; G06T 7/75; G06T 2207/30196

(57) ABSTRACT

Remediating ergonomic issues is provided. An ergonomic score corresponding to a user is generated based on differences between variations in physical positions of the user at a workstation and an ideal ergonomic setup corresponding to a target correct posture of the user at the workstation. An alert regarding the differences is sent to a client device of the user via a network. A set of remediation actions is performed based on the ergonomic score.

### BACKGROUND

### 1. Field

The disclosure relates generally to ergonomics and more specifically to providing real time intelligent ergonomic management to a user at a workstation.

### 2. Description of the Related Art

Ergonomics is the study of people's efficiency in their working environment. Ergonomics fits a job to a person to help lessen muscle fatigue, increases productivity, and reduce the number and severity of work-related musculoskeletal disorders (MSDs). Work-related MSDs are among the most frequently reported causes of lost or restricted work time. The goal of ergonomics is to eliminate discomfort and risk of injury due to work. In other words, the person is the uppermost priority in analyzing a workstation. Thus, ergonomics is concerned with designing and arranging of objects a person uses so that the person and objects interact efficiently and safely.

### SUMMARY

According to one illustrative embodiment, a computer-implemented method for remediating ergonomic issues is provided. A computer generates an ergonomic score corresponding to a user based on differences between variations in physical positions of the user at a workstation and an ideal ergonomic setup corresponding to a target correct posture of the user at the workstation. The computer sends an alert regarding the differences to a client device of the user via a network. The computer performs a set of remediation actions based on the ergonomic score. According to other illustrative embodiments, a computer system and computer program product for remediating ergonomic issues are provided.

### BRIEF DESCRIPTION OF THE DRAWINGS

FIG. 1 is a pictorial representation of a computing environment in which illustrative embodiments may be implemented;

FIG. 2 is a diagram illustrating an example of an ergonomic management system in accordance with an illustrative embodiment;

FIG. 3 is a diagram illustrating an example of a target correct posture in accordance with an illustrative embodiment;

FIG. 4 is a diagram illustrating an example of an ergonomic scoring process in accordance with an illustrative embodiment;

FIG. 5 is a diagram illustrating an example of an ergonomic scoring table in accordance with an illustrative embodiment; and

FIG. 6 is a flowchart illustrating a process for remediating ergonomic issues in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

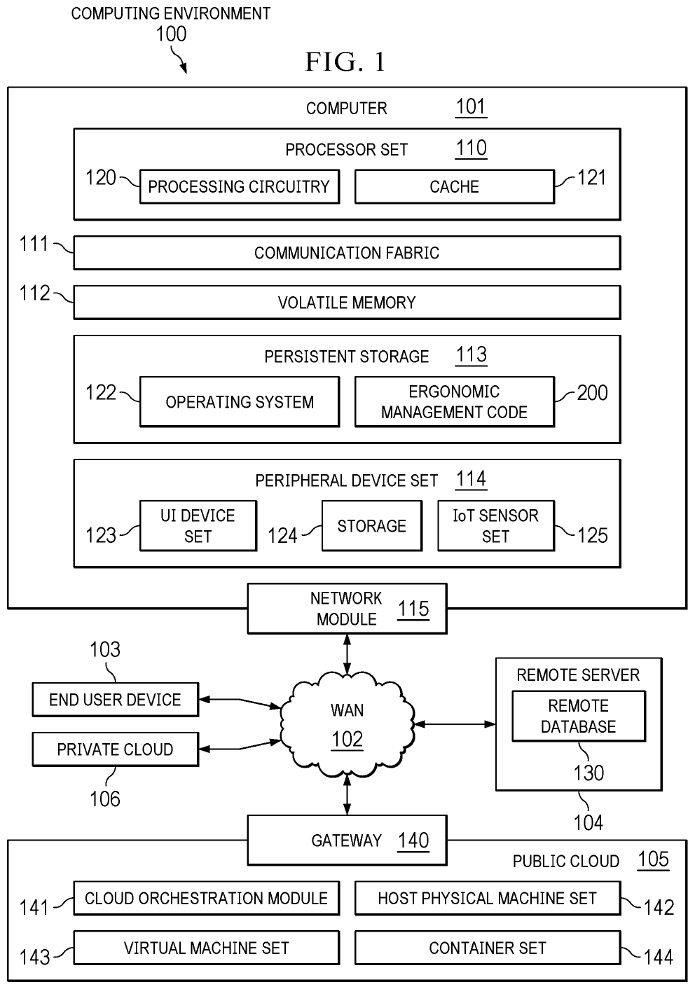

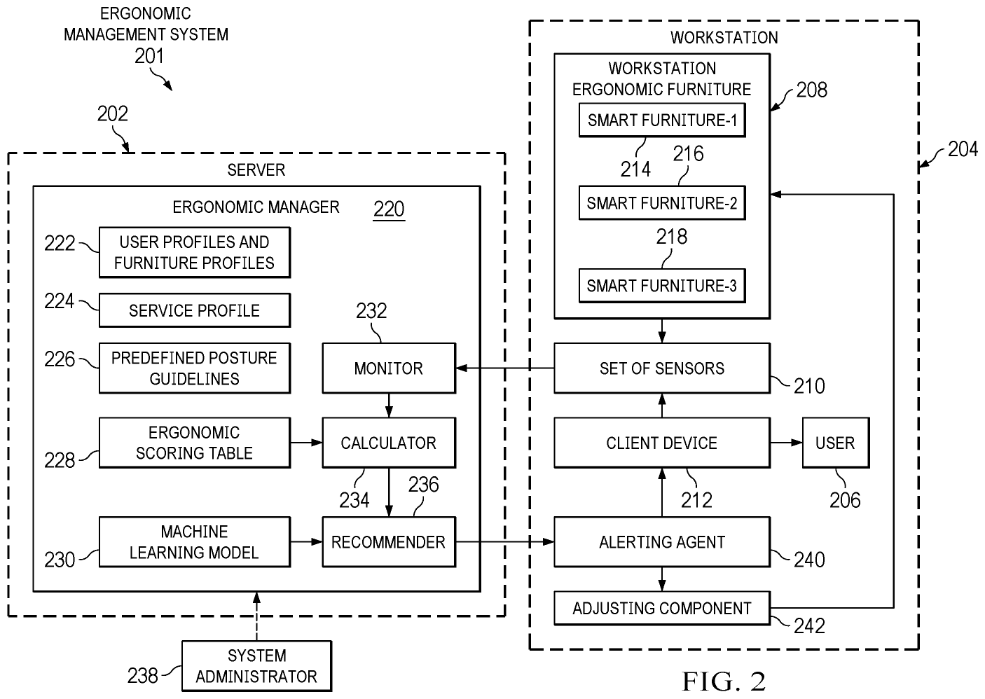

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as ergonomic management code 200. For example, ergonomic management code 200 enables real time intelligent ergonomic management by: monitoring variations in physical positions of a user at a workstation; identifying differences between the variations in the physical positions of the user at the workstation and an ideal ergonomic setup corresponding to a target correct posture of the user at the workstation; alerting the user based on identifying the differences; and automatically providing a set of remediation actions corresponding to the user and a set of ergonomic furniture associated with the workstation in real time to maintain the target correct posture of the user. Ergonomic management code 200 collects streaming data from a set of sensors (e.g., IoT sensors) associated with the user's workstation and utilize the collected sensor data to generate insights for the intelligent real time ergonomic management of the user at the workstation. Ergonomic management code 200 utilizes, for example, a machine learning model to evaluate and determine the target correct ergonomic posture of the user at the workstation based on the insights generated from the collected sensor data, predefined posture guidelines, physical attributes of the user, and attributes of the set of ergonomic furniture or devices located at the workstation.

Machine learning models can learn without being explicitly programmed to do so. For example, machine learning models can learn based on training data input into the machine learning models. Machine learning models can learn using various types of machine learning algorithms. The machine learning algorithms include at least one of supervised learning, semi-supervised learning, unsupervised learning, feature learning, sparse dictionary learning, association rules, or other types of learning algorithms. Examples of machine learning models can include artificial neural networks, convolutional neural networks, regression neural networks, decision trees, support vector machines, Bayesian networks, and other types of models. In this example, the machine learning model can be trained using defined postural guidelines, user physical attribute profiles, ergonomic furniture attribute profiles, and the like.

In addition to ergonomic management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ergonomic management code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in ergonomic management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The ergonomic management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a subscribing customer of the ergonomic management service provided by the entity that operates computer 101). EUD 103 may be, for example, a desktop computer, laptop computer, tablet computer, smart phone, smart watch, smart glasses, or the like. EUD 103 typically receives helpful and useful data from the operations of computer 101. For example, in a hypothetical case where computer 101 is designed to provide an ergonomic recommendation to the end user, this recommendation would typically be communicated from network module 115 of computer 101 through WAN 102 to EUD 103. In this way, EUD 103 can display, or otherwise present, the ergonomic recommendation to the end user. In some embodiments, EUD 103 may be a client device, such as thin client, heavy client, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an ergonomic recommendation based on historical ergonomic data, then this historical ergonomic data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Currently, no solution exists that generates an ergonomic indicator for a person from sensor data and then utilizes that ergonomic indicator to assist that person in performance of a task at a workstation. People who sit at desks to work are often not following proper ergonomic practices. Despite having knowledge of ergonomic practices and using ergonomic furniture, such as, for example, an adjustable laptop stand, adjustable computer monitor, adjustable desk, adjustable chair, adjustable footrest, and the like, people do not implement their knowledge of ergonomic practices, such as, for example, sitting with thighs parallel to floor, both feet on floor, sitting straight in chair (e.g., not slouching), monitor or screen at correct height (e.g., eye level), and the like. In addition, it can be difficult for a person to determine a correct amount of adjustment to ergonomic furniture to achieve correct ergonomic posture at the workstation.

Illustrative embodiments utilize a set of sensors (e.g., IoT sensors) located around a workstation (e.g., imaging devices, such as, cameras in a computer, mobile phone, security device, and the like) and sensors embedded in or on smart ergonomic furniture (e.g., height sensors, tilt sensors, weight sensors, vibration sensors, and the like) to monitor a user at the workstation in real time and determine whether the user is following proper ergonomic practices based on predefined posture guidelines and physical attributes of the user. Illustrative embodiments access the set of sensors via a network. Illustrative embodiments utilize the set of sensors to performing a diagnostic scan of the user's workstation setup and calibrate the user's posture and physical attributes (e.g., body size, arm length, leg length, and the like) to the workstation setup.

Illustrative embodiments receive streaming data from the set of sensors to continuously monitor the position of the user at the workstation and objects corresponding to the workstation (e.g., ergonomic desk, chair, footrest, monitor, and the like). For example, illustrative embodiments monitor for when the user is staring at the monitor screen for a predefined maximum amount of time without looking away, the user is sitting in the chair for a predefined maximum amount of time without getting up, the user is slouching (i.e., has incorrect posture) in the chair, the monitor screen height is not at eye level of the user, the keyboard is not centered to shoulder and arm placement, and the like. Illustrative embodiments generate an ergonomic score corresponding to the user based on the monitoring of the position of the user at the workstation, predefined posture guidelines, the user's physical attributes, and attributes of the ergonomic furniture. Illustrative embodiments send an ergonomic recommendation to the user regarding a target correct posture based on the ergonomic score.

Illustrative embodiments also send the ergonomic score corresponding to the user to an adjusting component to automatically adjust the set of smart ergonomic furniture (e.g., smart adjustable desk, smart adjustable chair, smart adjustable monitor stand, and the like) associated with the user's workstation to provide, for example, a 90-100 degree angle between forearms and arms, thighs parallel with the floor, monitor at eye level, back straight in chair, neck and head in alignment with back, and the like). Illustrative embodiments utilize a machine learning model to determine an ideal ergonomic setup corresponding to the target correct posture for the user at the workstation based on the predefined posture guidelines, the physical attributes of the user, and the physical attributes of the ergonomic furniture corresponding to the workstation.

Illustrative embodiments send an alert to the user in real time indicating at least the user's current posture relative to at least the target correct posture. Illustrative embodiments also generate a data structure (i.e., an ergonomic scoring table) to record and track user posture patterns over time corresponding to ergonomic furniture at a particular workstation. For example, the ergonomic scoring table can include columns for user identifier, ergonomic furniture identifier, user posture pattern types (e.g., head position, shoulder position, arm position, thigh position, foot position, and the like), current ergonomic score, predefined minimum ergonomic score threshold level, time of day, workstation location, and the like. Thus, illustrative embodiments are capable of providing dynamic ergonomic management by automatically adjusting smart ergonomic furniture associated with the workstation to correct poor posture of the user at the workstation based on real time analysis of sensor data to generate an ergonomic score corresponding to the user's current posture.

Illustrative embodiments recommend to the user the ideal ergonomic setup (e.g., suggest that the user sit up straight further back in the chair and adjust monitor up 1.2 inches) corresponding to the target correct posture at the workstation. Illustrative embodiments automatically adjust the ergonomic furniture or devices when possible. Otherwise, illustrative embodiments will direct the user to apply the adjustments manually. Further, illustrative embodiments utilize the machine learning model to continuously analyze the data received from the set of sensors regarding postural changes in the user at the workstation and any manual adjustments to the ergonomic furniture made by the user for human pose estimation to determine whether the user's ergonomic setup is regressing.

Thus, illustrative embodiments provide one or more technical solutions that overcome a technical problem with determining a correct amount of adjustment to ergonomic furniture to achieve correct ergonomic posture at the workstation to reduce user discomfort and risk of injury. As a result, these one or more technical solutions provide a technical effect and practical application in the field of ergonomics.

With reference now to FIG. 2, a diagram illustrating an example of an ergonomic management system is depicted in accordance with an illustrative embodiment. Ergonomic management system 201 may be implemented in a computing environment, such as computing environment 100 in FIG. 1. Ergonomic management system 201 is a system of hardware and software components for providing real time intelligent ergonomic management to users at workstations.

In this example, ergonomic management system 201 includes server 202 and workstation 204. Server 202 may be, for example, computer 101 in FIG. 1. In addition, it should be noted that ergonomic management system 201 is intended as an example only and not as a limitation on illustrative embodiments. For example, ergonomic management system 201 can include any number of servers, workstations, and other devices and components not shown.

Workstation 204 is where user 206 performs a set of tasks. Workstation 204 may be located in any type of environment, such as, for example, an office, workshop, industrial floor, assembly line, manufacturing plant, or the like. In this example, workstation 204 is located in an office environment, which includes workstation ergonomic furniture 208, set of sensors 210, and client device 212. Client device 212 corresponds to user 206 and may be, for example, EUD 103 in FIG. 1.

Workstation ergonomic furniture 208 represents a set of adjustable ergonomic furniture that assists user 206 in performance of the set of tasks. In this example, workstation ergonomic furniture 208 includes smart furniture-1 214, smart furniture-2 216, and smart furniture-3 218. Smart furniture-1 214, smart furniture-2 216, and smart furniture-3 218 represent devices that include mechanical components that can be automatically adjusted via electronic control signals received from server 202. In this example, smart furniture-1 214 is a smart adjustable ergonomic desk, smart furniture-2 216 is a smart adjustable ergonomic chair, and smart furniture-3 218 is a smart adjustable ergonomic monitor. However, smart furniture-1 214, smart furniture-2 216, and smart furniture-3 218 can be any type of smart adjustable furniture utilized by user 206 at workstation 204.

Set of sensors 210 can be, for example, IoT sensors, which correspond to workstation 204. Set of sensors 210 can include, for example, a set of security cameras located around workstation 204, a camera located in client device 212, a camera located in the monitor, and a set of sensors (e.g., height sensors, tilt sensors, and the like) located in or on each of smart furniture-1 214, smart furniture-2 216, and smart furniture-3 218. Set of sensors 210 collect streaming data regarding the position and posture of user 206 in relation to workstation ergonomic furniture 208 at workstation 204. Set of sensors 210 send the streaming data regarding the position and posture of user 206 to ergonomic manager 220 of server 202.

Ergonomic manager 220 can be implemented in, for example, ergonomic management code 200 in FIG. 1. Ergonomic manager 220 includes a plurality of components, such as user profiles and furniture profiles 222, service profile 224, predefined posture guidelines 226, ergonomic scoring table 228, machine learning model 230, monitor 232, calculator 234, and recommender 236. However, it should be noted that ergonomic manager 220 is intended as an example only and not as a limitation on illustrative embodiments. In other words, ergonomic manager 220 can include more or fewer components than shown. For example, two or more components can be combined into one component, one component can be divided into two or more components, one or more components can be removed, or one or more components not shown can be added.

System administrator 238 loads user profiles and furniture profiles 222, service profile 224, predefined posture guidelines 226, and any other relevant information into ergonomic manager 220. User profiles and furniture profiles 222 represent a plurality of different profiles corresponding to a plurality of different users, such as user 206, and a plurality of different ergonomic furniture, such as of smart furniture-1 214, smart furniture-2 216, and smart furniture-3 218. The user profile corresponding to user 206 includes information, such as, for example, a unique identifier corresponding to user 206, unique identifier and location of each workstation corresponding to user 206 such as workstation 204, unique identifier and type of each client device corresponding to user 206 such as client device 212, and physical attributes corresponding to user 206 such as height, torso length, arm length, forearm length, thigh length, leg length, and the like. The furniture profile corresponding to each of smart furniture-1 214, smart furniture-2 216, and smart furniture-3 218 includes information, such as, for example, unique identifier and type of that particular piece of smart adjustable ergonomic furniture, identification of adjustable components of that particular piece of smart adjustable ergonomic furniture, and attributes of that particular piece of smart adjustable ergonomic furniture such as dimensions, measurements, properties, features, aspects, and the like.

Service profile 224 includes the types or levels of services provided by ergonomic manager 220 to users such as user 206. The types of services can include, for example, an alerting service only, an automatic furniture adjusting service only, or a combination of alerting and automatic furniture adjusting services. In this example, service profile 224, which corresponding to user 206, is the combination of the alerting and automatic furniture adjusting services.

Predefined posture guidelines 226 represent a set of standards for human posture in different positions such as standing, sitting, laying, and the like. Predefined posture guidelines 226 are in relation to the frontal plane and the sagittal plane of the human body. For example, predefined posture guidelines 226 delineate alignment of body parts (e.g., head, shoulders, back, hips, thighs, and legs) for correct posture in relation to the frontal and sagittal planes. Further, predefined posture guidelines 226 also delineate what is incorrect posture with regard to the different body parts in relation to the frontal and sagittal planes.

Ergonomic manager 220 generates ergonomic scoring table 228 based on the streaming data received from set of sensors 210, user profiles and furniture profiles 222, and predefined posture guidelines 226. Ergonomic scoring table 228 contains an ergonomic score for user 206 while using smart furniture-1 214, smart furniture-2 216, and smart furniture-3 218 at workstation 204.

Ergonomic manager 220 utilizes machine learning model 230 to analyze the streaming data received from set of sensors 210 corresponding to user 206 and the setup workstation 204 and determine an ideal ergonomic setup corresponding to a target correct posture of user 206 while utilizing workstation ergonomic furniture 208 at workstation 204. Machine learning model 230 determines the ideal ergonomic setup corresponding to the target correct posture of user 206 based on the analysis of the streaming data received from set of sensors 210, information corresponding to user 206 and smart furniture-1 214, smart furniture-2 216, and smart furniture-3 218 contained in user profiles and furniture profiles 222, and predefined posture guidelines 226.

Ergonomic manager 220 utilizes monitor 232 to receive the streaming data from set of sensors 210 and continuously monitor for positional changes in user 206 while utilizing workstation ergonomic furniture 208 at workstation 204. Ergonomic manager 220 utilizes calculator 234 to calculate the ergonomic score corresponding to user 206. Ergonomic manager 220 utilizes recommender 236 to send an ergonomic recommendation to user 206 via alerting agent 240 based on machine learning model 230 determining the difference between the current position of user 206 and the ideal ergonomic setup corresponding to the target correct posture of user 206.

Alerting agent 240 can be located in client device 212. Alternatively, alerting agent 240 can be located in another device, such as, for example, a personal assistant device, located at workstation 204. Moreover, alerting agent 240 can pass the ergonomic recommendation on to adjusting component 242. Alternatively, adjusting component 242 can receive the ergonomic recommendation directly from recommender 236. Adjusting component 242 automatically adjusts at least one of smart furniture-1 214, smart furniture-2 216, or smart furniture-3 218 to correct the posture of user 206 in accordance with the target correct posture. It should be noted that adjusting component 242 is located in each of smart furniture-1 214, smart furniture-2 216, and smart furniture-3 218.

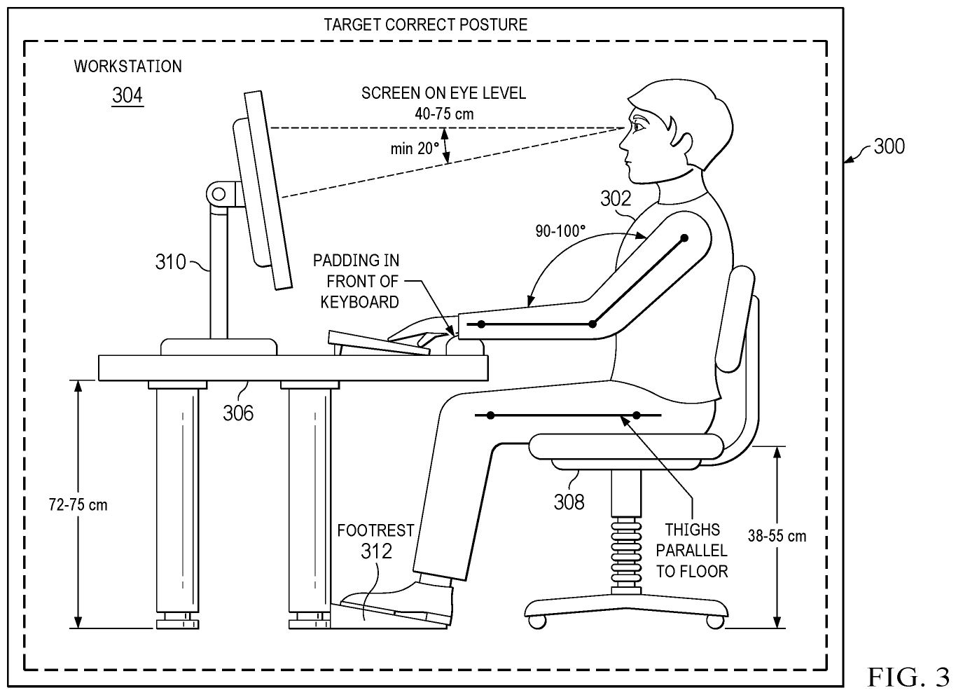

With reference now to FIG. 3, a diagram illustrating an example of a target correct posture is depicted in accordance with an illustrative embodiment. Target correct posture 300 corresponds to user 302 at workstation 304. User 302 and workstation 304 may be, for example, user 206 and workstation 204 in FIG. 2. An ergonomic manager, such as ergonomic manager 220 in FIG. 2, utilizing a machine learning model, such as machine learning model 230 in FIG. 2, determines target correct posture 300 for user 302 based on, for example: physical attributes of user 302 that are contained in a user profile corresponding to user 302; attributes of smart adjustable ergonomic desk 306, smart adjustable ergonomic chair 308, smart adjustable ergonomic monitor 310, and smart adjustable ergonomic footrest 312 that are contained in a furniture profile corresponding to each of smart adjustable ergonomic desk 306, smart adjustable ergonomic chair 308, smart adjustable ergonomic monitor 310, and smart adjustable ergonomic footrest 312; and predefined posture guidelines, such as, for example, predefined posture guidelines 226 in FIG. 2. Target correct posture 300 illustrates a proper posture for user 302 while utilizing smart adjustable ergonomic desk 306, smart adjustable ergonomic chair 308, smart adjustable ergonomic monitor 310, and smart adjustable ergonomic footrest 312 at workstation 304.

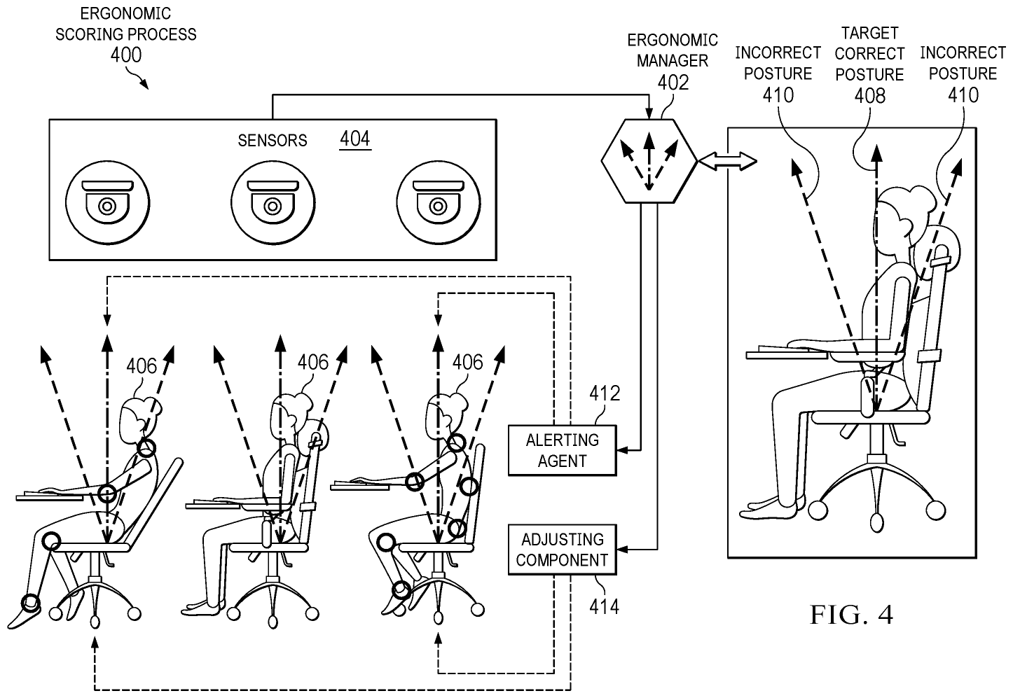

With reference now to FIG. 4, a diagram illustrating an example of an ergonomic scoring process is depicted in accordance with an illustrative embodiment. Ergonomic scoring process 400 is implemented in ergonomic manager 402, such as, for example, ergonomic manager 220 in FIG. 2.

Ergonomic manager 402 receives streaming data from sensors 404 regarding user 406 at a workstation. Sensors 404 and user 406 may be, for example, set of sensors 210 and user 206 in FIG. 2. Ergonomic manager 402 determines whether user 406 is in target correct posture 408, such as, for example, target correct posture 300 in FIG. 3, or in one of incorrect postures 410. Ergonomic manager 402 determines whether user 406 is in target correct posture 408 or in one of incorrect postures 410 based on analysis of the streaming data received from sensors 404, physical attributes of user 406, attributes of the ergonomic furniture utilized by user 406 at the workstation, and predefined posture guidelines.

In response to ergonomic manager 402 determining that user 406 is in one of incorrect postures 410, ergonomic manager 402 sends an ergonomic recommendation to user 406 via alerting agent 412, such as, for example, alerting agent 240 in FIG. 2. Further, ergonomic manager 402 sends control signals to adjusting component 414, such as, for example, adjusting component 242 in FIG. 2, to automatically adjust the smart adjustable ergonomic furniture to correct the posture of user 406 in accordance with target correct posture 408.

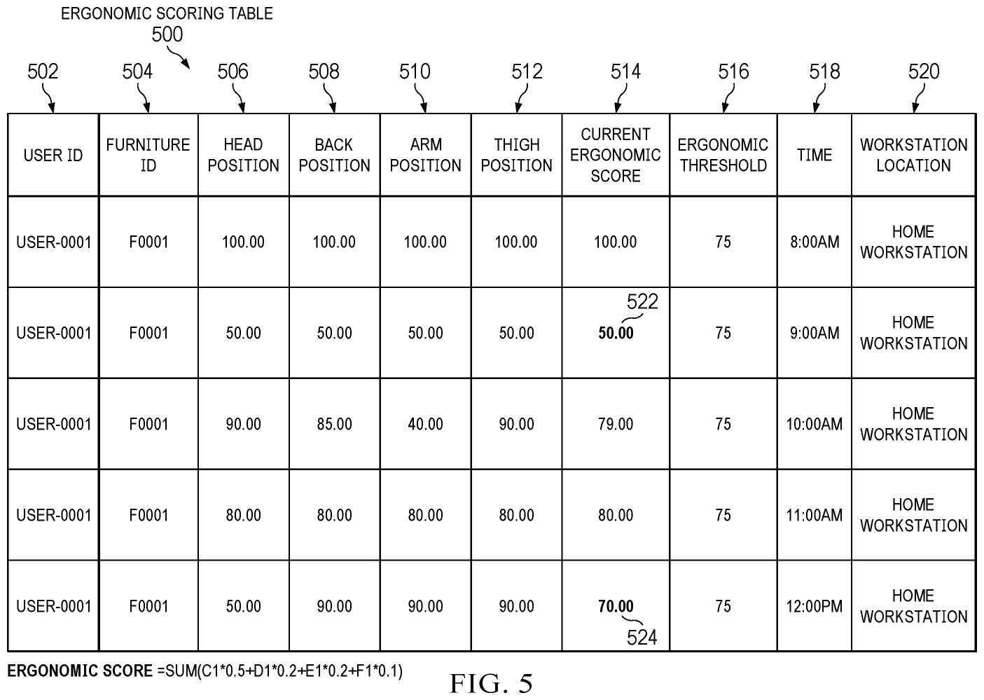

With reference now to FIG. 5, a diagram illustrating an example of an ergonomic scoring table is depicted in accordance with an illustrative embodiment. Ergonomic scoring table 500 may be, for example, ergonomic scoring table 228 implemented in ergonomic manager 220 of FIG. 2.

In this example, ergonomic scoring table 500 includes user identifier 502, furniture identifier 504, head position 506, back position 508, arm position 510, thigh position 512, current ergonomic score 514, ergonomic threshold 516, time 518, and workstation location 520. User identifier 502 uniquely identifies a particular user, such as, for example, user 206 in FIG. 2. Furniture identifier 504 uniquely identifies a particular piece of ergonomic furniture, such as, for example, smart furniture-1 214 in FIG. 2. Head position 506, back position 508, arm position 510, and thigh position 512 identify the current positions of these particular body parts of the user at a workstation, such as, for example, workstation 204 in FIG. 2. Current ergonomic score 514 shows the current ergonomic score of the user based on head position 506, back position 508, arm position 510, and thigh position 512. Ergonomic threshold 516 represents a minimum ergonomic score threshold level, which in this example, is 75. However, ergonomic threshold 516 is meant as an example only and may be set at any level. Time 518 indicates the time of day when current ergonomic score 514 was generated. Workstation location 520 indicates where the workstation is located, which in this example is at the home of the user. Also in this example, the ergonomic manager sends an alert with an ergonomic recommendation to the user because current ergonomic score 514 at 522 and 524 is below ergonomic threshold 516.

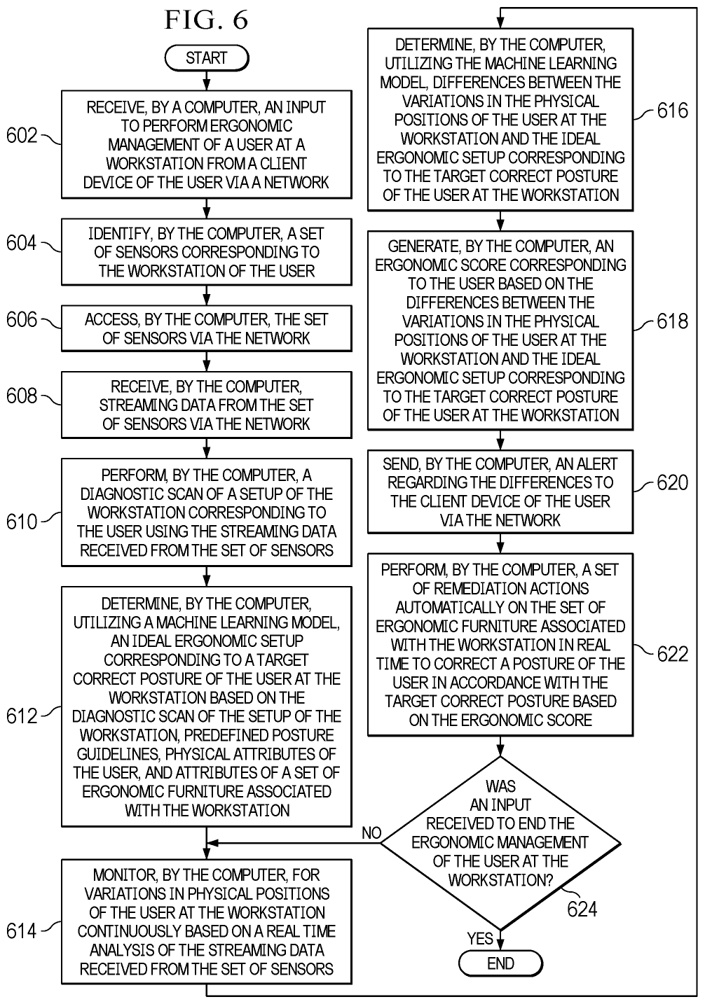

With reference now to FIG. 6, a flowchart illustrating a process for remediating ergonomic issues is shown in accordance with an illustrative embodiment. The process shown in FIG. 6 may be implemented in a computer, such as, for example, computer 101 in FIG. 1 or server 202 in FIG. 2. For example, the process shown in FIG. 6 may be implemented in ergonomic management code 200 in FIG. 1 or ergonomic manager 220 in FIG. 2.

The process begins when the computer receives an input to perform ergonomic management of a user at a workstation from a client device of the user via a network (step 602). The network may be, for example, WAN 102 in FIG. 1. In response to receiving the input to perform the ergonomic management of the user at the workstation, the computer identifies a set of sensors corresponding to the workstation of the user (step 604).

In response to identifying the set of sensors access, the computer accesses the set of sensors via the network (step 606). Further, the computer receives streaming data from the set of sensors via the network (step 608). Furthermore, the computer performs a diagnostic scan of a setup of the workstation corresponding to the user using the streaming data received from the set of sensors (step 610).

Subsequently, the computer, utilizing a machine learning model, determines an ideal ergonomic setup corresponding to a target correct posture of the user at the workstation based on the diagnostic scan of the setup of the workstation, predefined posture guidelines, physical attributes of the user, and attributes of a set of ergonomic furniture associated with the workstation (step 612). In addition, the computer continuously monitors for variations in physical positions of the user at the workstation based on a real time analysis of the streaming data received from the set of sensors (step 614). The computer, utilizing the machine learning model, determines differences between the variations in the physical positions of the user at the workstation and the ideal ergonomic setup corresponding to the target correct posture of the user at the workstation (step 616).

Afterward, the computer generates an ergonomic score corresponding to the user based on the differences between the variations in the physical positions of the user at the workstation and the ideal ergonomic setup corresponding to the target correct posture of the user at the workstation (step 618). The computer sends an alert regarding the differences to the client device of the user via the network (step 620). Moreover, the computer performs a set of remediation actions automatically on the set of ergonomic furniture associated with the workstation in real time to correct a posture of the user in accordance with the target correct posture based on the ergonomic score (step 622).

Then, the computer makes a determination as to whether an input was received to end the ergonomic management of the user at the workstation (step 624). If the computer determines that no input was received to end the ergonomic management of the user at the workstation, no output of step 624, then the process returns to step 614 where the computer continues to monitor for variations in the physical position of the user at the workstation. If the computer determines that an input was received to end the ergonomic management of the user at the workstation, yes output of step 624, then the process terminates thereafter.

Thus, illustrative embodiments of the present invention provide a computer-implemented method, computer system, and computer program product for providing real time intelligent ergonomic management to a user at a workstation. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for remediating ergonomic issues, the computer-implemented method comprising:
generating, by a computer, an ergonomic score corresponding to a user based on differences between variations in physical positions of the user at a workstation and an ideal ergonomic setup corresponding to a target correct posture of the user at the workstation;
sending, by the computer, an alert regarding the differences to a client device of the user via a network; and
performing, by the computer, a set of remediation actions based on the ergonomic score.

2. The computer-implemented method of claim 1, further comprising:
identifying, by the computer, a set of sensors corresponding to the workstation of the user in response to receiving an input to perform ergonomic management of the user at the workstation from the client device of the user via the network;
accessing, by the computer, the set of sensors via the network; and
receiving, by the computer, streaming data from the set of sensors via the network.

3. The computer-implemented method of claim 2, further comprising:
performing, by the computer, a diagnostic scan of a setup of the workstation corresponding to the user using the streaming data received from the set of sensors; and
determining, by the computer, the ideal ergonomic setup corresponding to the target correct posture of the user at the workstation based on the diagnostic scan of the setup of the workstation, predefined posture guidelines, physical attributes of the user, and attributes of a set of ergonomic furniture associated with the workstation.

4. The computer-implemented method of claim 3, further comprising:
monitoring, by the computer, for the variations in the physical positions of the user at the workstation based on a real time analysis of the streaming data received from the set of sensors; and
determining, by the computer, the differences between the variations in the physical positions of the user at the workstation and the ideal ergonomic setup corresponding to the target correct posture of the user at the workstation.

5. The computer-implemented method of claim 4, wherein the computer utilizes a machine learning model to determine the ideal ergonomic setup corresponding to the target correct posture of the user at the workstation and the differences between the variations in the physical positions of the user at the workstation and the ideal ergonomic setup corresponding to the target correct posture of the user at the workstation.

6. The computer-implemented method of claim 5, wherein inputs to the machine learning model include the streaming data received from the set of sensors.

7. The computer-implemented method of claim 1, wherein the computer automatically performs the set of remediation actions on a set of ergonomic furniture associated with the workstation in real time to correct a posture of the user in accordance with the target correct posture.

8. The computer-implemented method of claim 7, wherein the set of ergonomic furniture is a set of smart ergonomic furniture, each piece of smart ergonomic furniture includes an adjusting component that receives control signals from the computer to correct the posture of the user in accordance with the target correct posture.

9. A computer system for remediating ergonomic issues, the computer system comprising:
a communication fabric;
a storage device connected to the communication fabric, wherein the storage device stores program instructions; and
a processor connected to the communication fabric, wherein the processor executes the program instructions to:
generate an ergonomic score corresponding to a user based on differences between variations in physical positions of the user at a workstation and an ideal ergonomic setup corresponding to a target correct posture of the user at the workstation;
send an alert regarding the differences to a client device of the user via a network; and
perform a set of remediation actions based on the ergonomic score.

10. The computer system of claim 9, wherein the processor further executes the program instructions to:
identify a set of sensors corresponding to the workstation of the user in response to receiving an input to perform ergonomic management of the user at the workstation from the client device of the user via the network;
access the set of sensors via the network; and
receive streaming data from the set of sensors via the network.

11. The computer system of claim 10, wherein the processor further executes the program instructions to:
perform a diagnostic scan of a setup of the workstation corresponding to the user using the streaming data received from the set of sensors; and
determine the ideal ergonomic setup corresponding to the target correct posture of the user at the workstation based on the diagnostic scan of the setup of the workstation, predefined posture guidelines, physical attributes of the user, and attributes of a set of ergonomic furniture associated with the workstation.

12. The computer system of claim 11, wherein the processor further executes the program instructions to:
monitor for the variations in the physical positions of the user at the workstation based on a real time analysis of the streaming data received from the set of sensors; and
determine the differences between the variations in the physical positions of the user at the workstation and the ideal ergonomic setup corresponding to the target correct posture of the user at the workstation.

13. The computer system of claim 12, wherein the processor utilizes a machine learning model to determine the ideal ergonomic setup corresponding to the target correct posture of the user at the workstation and the differences between the variations in the physical positions of the user at the workstation and the ideal ergonomic setup corresponding to the target correct posture of the user at the workstation.

14. A computer program product for remediating ergonomic issues, the computer program product comprising a computer-readable storage medium having program instructions embodied therewith, the program instructions executable by a computer to cause the computer to perform a method of:
generating, by the computer, an ergonomic score corresponding to a user based on differences between variations in physical positions of the user at a workstation and an ideal ergonomic setup corresponding to a target correct posture of the user at the workstation;
sending, by the computer, an alert regarding the differences to a client device of the user via a network; and
performing, by the computer, a set of remediation actions based on the ergonomic score.

15. The computer program product of claim 14, further comprising:
identifying, by the computer, a set of sensors corresponding to the workstation of the user in response to receiving an input to perform ergonomic management of the user at the workstation from the client device of the user via the network;
accessing, by the computer, the set of sensors via the network; and
receiving, by the computer, streaming data from the set of sensors via the network.

16. The computer program product of claim 15, further comprising:
performing, by the computer, a diagnostic scan of a setup of the workstation corresponding to the user using the streaming data received from the set of sensors; and
determining, by the computer, the ideal ergonomic setup corresponding to the target correct posture of the user at the workstation based on the diagnostic scan of the setup of the workstation, predefined posture guidelines, physical attributes of the user, and attributes of a set of ergonomic furniture associated with the workstation.

17. The computer program product of claim 16, further comprising:
monitoring, by the computer, for the variations in the physical positions of the user at the workstation based on a real time analysis of the streaming data received from the set of sensors; and
determining, by the computer, the differences between the variations in the physical positions of the user at the workstation and the ideal ergonomic setup corresponding to the target correct posture of the user at the workstation.

18. The computer program product of claim 17, wherein the computer utilizes a machine learning model to determine the ideal ergonomic setup corresponding to the target correct posture of the user at the workstation and the differences between the variations in the physical positions of the user at the workstation and the ideal ergonomic setup corresponding to the target correct posture of the user at the workstation.

19. The computer program product of claim 18, wherein inputs to the machine learning model include the streaming data received from the set of sensors.

20. The computer program product of claim 14, wherein the computer automatically performs the set of remediation actions on a set of ergonomic furniture associated with the workstation in real time to correct a posture of the user in accordance with the target correct posture.
